(19) United States
(12) Patent Application Publication
(10) Pub. No.: US 2021/0193335 A1
(43) Pub. Date: Jun. 24, 2021

(54) METHOD AND DEVICE FOR CAPTURING IMAGES IN AN INTERNET OF THINGS ENVIRONMENT

(71) Applicant: Samsung Electronics Co., Ltd., Suwon-si (KR)

(72) Inventors: Mugula Satya Shankar Kameshwar SHARMA, Bangalore (IN); Harit SHARMA, Bangalore (IN)

(21) Appl. No.: 17/117,680

(22) Filed: Dec. 10, 2020

(30) Foreign Application Priority Data
Dec. 24, 2019 (IN) 201941053751

(51) Int. Cl. G16Y 40/35; G16Y 20/10; G16Y 30/00; G06K 9/00; H04W 84/18

(52) U.S. Cl. CPC G16Y 40/35; G16Y 20/10; H04W 84/18; G06K 9/0063; G16Y 30/00

(57) ABSTRACT

A method performed by an electronic device in a capturing environment is provided. The method includes determining identification information for providing a user with candidate information for a user selection; identifying one or more devices that are associated with the capturing environment; acquiring mode information representing a mode for each of the one or more devices based on the user selection; operating the one or more devices based on the acquired mode information; and capturing an image in the capturing environment.

### CROSS-REFERENCE TO RELATED APPLICATION(S)

The application is based on and claims priority under 35 U.S.C. § 119(a) of an India patent application number 201941053751, filed on Dec. 24, 2019 in the Indian Patent Office, the disclosure of which is incorporated by reference herein in its entirety.

### BACKGROUND

### 1. Field

The disclosure relates to capturing of images. More particularly, the disclosure relates to capturing of images in an Internet of Things (IoT) environment.

### 2. Description of Related Art

Current mechanisms for capturing images typically provide a user with a plurality of camera settings for adjusting image characteristics, such as brightness, contrast, and the like, associated with an image. Said settings may be adjusted by the user either during a preview frame associated with a yet to be captured image or post capturing of the image. Additionally, a plurality of predefined filters may be provided to the user for capturing the images using said filters. Said filters have corresponding predefined image characteristic settings that are applied to the preview frame prior to capturing of the image, the techniques of capturing images of the related art are either static or limited to changing camera properties during capturing of images.

Therefore, there is a need for a solution to address at least one of the aforementioned problems.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is provided to introduce a selection of concepts, in a simplified format, that are further described in the detailed description of the disclosure. This summary is neither intended to identify key or essential inventive concepts of the disclosure and nor is it intended for determining the scope of the disclosure.

Additional aspects will be set forth in part in the description which follows and, in part, will be apparent from the description, or may be learned by practice of the presented embodiments.

In accordance with an aspect of the disclosure, a method performed by an electronic device in a capturing environment is provided. The method includes determining identification information for providing a user with candidate information for a user selection, identifying one or more devices that are associated with the capturing environment, acquiring mode information representing a mode for each of the one or more devices based on the user selection, operating the one or more devices based on the acquired mode information, and capturing an image in the capturing environment.

In accordance with another aspect of the disclosure, an electronic device in a capturing environment is provided. The electronic device includes a display, a memory, and at least one processor configured to determine identification information for providing a user with candidate information for a user selection, identifying one or more devices that are associated with the capturing environment, acquire mode information representing a mode for each of the one or more devices based on the user selection, operate the one or more devices based on the acquired mode information, and capture an image in the capturing environment.

To further clarify advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features and advantages of certain embodiments of the disclosure will be more apparent from the following description taken in conjunction with the accompanying drawings, in which:

FIG. 1 illustrates an environment implementing a system for capturing images in an Internet of Things (IoT) environment, according to an embodiment of the disclosure;

FIG. 2 illustrates a detailed block diagram of the system, according to an embodiment of the disclosure;

FIG. 3 illustrates a method of capturing images in an IoT environment, according to an embodiment of the disclosure;

FIG. 4 illustrates a method of capturing images in an IoT environment, according to an embodiment of the disclosure;

FIG. 5 illustrates a method of creating IoT camera modes in an IoT environment, according to an embodiment of the disclosure;

FIG. 6 illustrates a flow chart of an operating method of an electronic device according to an embodiment of the disclosure; and

FIG. 7 illustrates a block diagram of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents. It is to be understood that the singular forms “a,” “an,” and “the” include plural referents unless the context clearly dictates otherwise. Thus, for example, reference to “a component surface” includes reference to one or more of such surfaces.

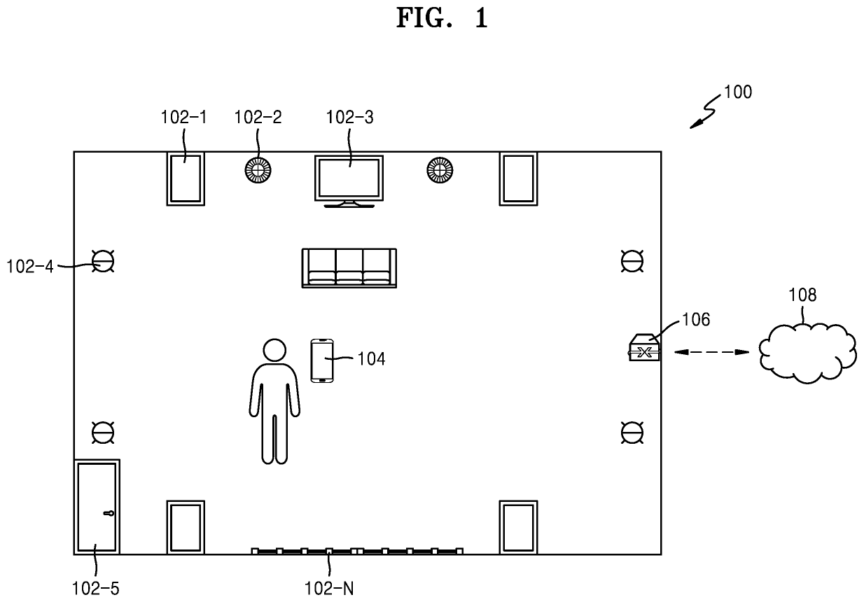

FIG. 1 illustrates an environment 100 in which various embodiments of the disclosure may be implemented according to an embodiment of the disclosure.

Referring to FIG. 1, the environment 100 includes a plurality of devices 102-1, 102-2, 102-3, 102-4, 102-5 and 102-N. Examples of the devices 102-1, 102-2, 102-3, 102-4, 102-5 and 102-N may include but are not limited to, a window, a floor lamp, a Television, a ceiling lamp, a door, and a curtain. In an example, each of the devices 102-1, 102-2, 102-3, 102-4, 102-5 and 102-N may be provisioned to operate such that they form part of a smart home or Internet of Things (IoT) environment. In other words, operation of the devices 102-1, 102-2, 102-3, 102-4, 102-5 and 102-N may be controlled using a user device 104. For example, the curtains may be drawn or closed, the ceiling lamp may be switched ON/OFF, and the TV may be switched ON/OFF, using the user device 104. Examples of the user device 104 may include but are not limited to, a smartphone, a tablet, a laptop, a wearable smart device, and a desktop computer.

As mentioned above, the environment 100 provides for controlling of the devices 102 using the user device 104 and accordingly may serve as an IoT environment. Thus, the environment 100 may be interchangeably referred to as the IoT environment 100. Accordingly, the devices 102 may be interchangeably referred to as IoT devices 102.

The environment 100 further includes a gateway 106. The gateway 106 may be configured to connect and facilitate the exchange of data and signals between the devices 102-1, 102-2, 102-3, 102-4, 102-5 and 102-N and the user device 104. Furthermore, the gateway 106 may be connected to a cloud 108 and may be configured to facilitate storage/retrieval of data to/from the cloud 108.

According to an embodiment of the disclosure, the user device 104 may be configured to implement a system for capturing an image in the IoT environment. In the example embodiment, the system may be configured to provide the user who is seeking to capture the image, with an option of recreating a past ambience and then capture the image. More specifically, when the user is seeking to capture the image, the system learns about a location within the IoT environment based on a camera preview frame. Once the location is determined, the system may be configured to provide the user with either (a) a plurality of candidate IoT camera modes; or (b) a plurality of pre-stored images based on the location. The plurality of candidate IoT camera modes or the plurality of pre-stored images may be provided to the user, for example, using a display of the user device 104.

The term IoT camera mode, as used herein, may be understood as an image capturing mode provided to a user when capturing images using the user device 104. The IoT camera mode provides the user with an option to operate one or more IoT devices 102-1, 102-2, 102-3, 102-4, 102-5 and 102-N that are present in the location where the image is being captured, as per their respective past operation settings. Accordingly, the user may be able to re-create a past ambience in real-time and then capture the image in the re-created past ambience. This allows the user with ease and convenience of capturing images.

As mentioned above, the user may also be provided with a plurality of pre-stored images based on the location where the user is capturing the image within the IoT environment 100. Each of said pre-stored images is an image that was previously captured at the location where the image is now being captured in real-time. When presented with the plurality of pre-stored images, the user may make trial selections of the pre-stored images. That is, the user may make a trial selection of multiple pre-stored images one after another. Upon each trial selection, the camera preview frame may be updated based on the trial-selected pre-stored image. The updating may include application of a plurality of visual effects on the camera preview frame, so as to make it visually similar to a past ambience of the previously captured image. The similarity, in an example, may be in terms of the image characteristics. For instance, the brightness of the image being captured in real time may be adjusted in the camera preview frame so as to make it visually similar to the pre-stored image. The similarity, in an example, may be achieved only to an extent as possible as per the operation of the IoT devices 102-1, 102-2, 102-3, 102-4, 102-5 and 102-N present at the location. For instance, the capabilities of the IoT devices 102-1, 102-2, 102-3, 102-4, 102-5 and 102-N, such as brightness of the lights present at the location, may be learnt. Accordingly, the extent to which such lights may be operated so as to produce the nearest possible similarity in terms of brightness to the pre-stored image may be determined. Accordingly, the camera preview frame is updated to reflect said extent. This provides the user with an accurate preview of how the image would look in real-time. Accordingly, the user may select a pre-stored image. On selection of a pre-stored image, the set of IoT devices 102-1, 102-2, 102-3, 102-4, 102-5 and 102-N present at the location may be operated based on past operation data so as to re-create the past ambience in real-time at the determined location. Subsequently, the user may capture the image as per the past ambience that is re-created in real-time.

The re-creation of the past ambience in real-time may not be construed as limited to an absolute re-creation of the past ambience. As may be understood, such re-creation may be to the nearest extent possible and may be dependent on one or more factors, such as the set of IoT devices 102-1, 102-2, 102-3, 102-4, 102-5 and 102-N still present at the location and/or external lighting.

Referring to the IoT camera modes and the pre-stored images, in an example, whenever an image is captured using the user device 104, the system may be configured to ascertain the location associated with the captured image. Furthermore, the system may also determine the set of IoT devices 102-1, 102-2, 102-3, 102-4, 102-5 and 102-N present at the location and their respective operation settings. The operation settings of the set of IoT devices 102-1, 102-2, 102-3, 102-4, 102-5 and 102-N may be referred to as operation data. In an example, the location and the operation data may be stored as IoT metadata and may be associated with the image. In addition to the operation data and the location, a context associated with the image may also be determined and stored in the IoT metadata. Now, in an example, an IoT camera mode may be created based on the operation settings of the set of IoT devices 102-1, 102-2, 102-3, 102-4, 102-5 and 102-N and may be associated with the IoT metadata. The IoT metadata may be stored in the central storage. In an example, the images, the associated IoT metadata, and the IoT camera modes may be stored in a central storage, say, the cloud 108, and hence may be accessible by all the users registered with the IoT environment 100.

In operation, in an example where the user is presented with the IoT camera modes, the user may select an IoT camera mode. Accordingly, an operation of each of the set of IoT devices 102-1, 102-2, 102-3, 102-4, 102-5 and 102-N is controlled based on IoT metadata associated with the selected IoT camera mode for re-creating the past ambience in real-time. Once the past ambience is re-created, the user may then provide a user input for capturing the image using the user device 104.

In an example where the user is presented with the pre-stored images, the user may select a pre-stored image. Accordingly, an operation of each of the set of IoT devices 102-1, 102-2, 102-3, 102-4, 102-5 and 102-N may be controlled based on IoT metadata associated with the selected pre-stored image for re-creating the past ambience in real-time. Once the past ambience is re-created, the user may then provide a user input for capturing the image using the user device 104.

In a further example, besides the location where the image is being captured, a context as determined based on the camera preview frame may also be used for selecting the plurality of IoT camera modes and the plurality of pre-stored images that may be provided to the user for selection.

Thus, according to aspects of the disclosure, users are able to recreate past ambience relative to the location where they are capturing an image in real-time. Furthermore, the user may also be able to re-create the past ambience as per the contexts as well. This facilitates in capturing of images and enhances user experience. For instance, for recurring events, the user may choose predefined IoT device 102-1, 102-2, 102-3, 102-4, 102-5 and 102-N operation settings, as per the IoT camera modes created by the system. Accordingly, the user may easily be able to recreate past ambiences and may not need to remember the settings for each of the IoT devices. Likewise, using the pre-stored images, the user may be presented with an indication of the end visual effects of the yet to be captured image as per specific operation settings of the IoT devices. Specifically, the lighting of the ambient environment may be adjusted as per previously captured images to produce or recreate previous ambient environment that may appeal to the user.

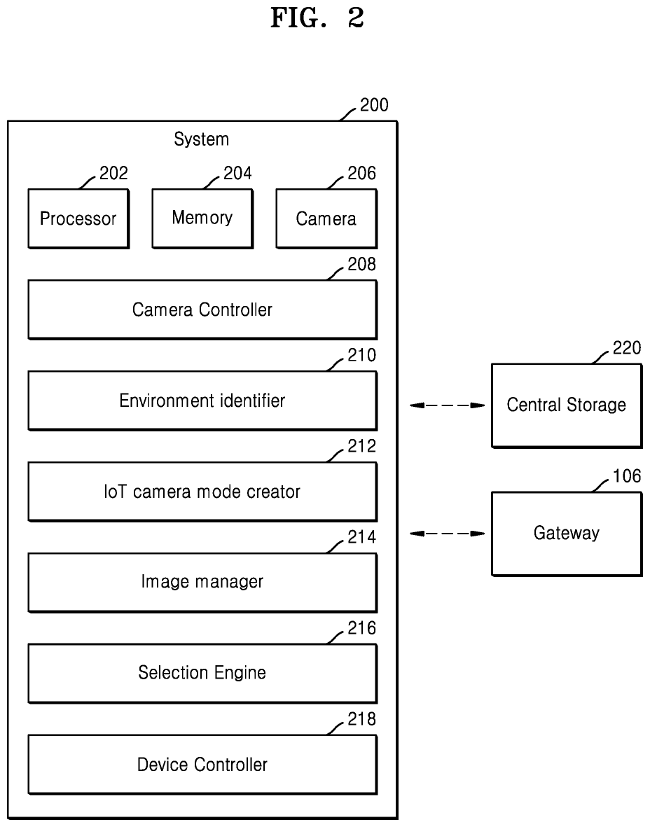

FIG. 2 illustrates a detailed block diagram of a system 200, according to an embodiment of the disclosure.

Referring to FIG. 2, the system 200, according to embodiments of the present disclosure, may be implemented in a user device, such as the user device 104, for capturing images in an IoT environment, such as the IoT environment 100. In an example, the system 200 comprises a processor 202, memory 204, and camera 206. The processor 202 can be a single processing unit or a number of units, all of which could include multiple computing units. The processor 202 may be implemented as one or more microprocessors, microcomputers, microcontrollers, digital signal processors, central processing units, graphical processing units, neural processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The camera 206 may be a camera of the user device and may be used for recording multimedia, such as images, videos, etc.

The system further comprises a camera controller 208, an environment identifier 210, an IoT camera mode creator 212, an image manager 214, a selection engine 216, and a device controller 218. In an example, the camera controller 208, the environment identifier 210, the IoT camera mode creator 212, the image manager 214, the selection engine 216, and the device controller 218 may be coupled to the processor 202. In an example, the camera controller 208, the environment identifier 210, the IoT camera mode creator 212, the image manager 214, the selection engine 216, and the device controller 218, amongst other things, include routines, programs, objects, components, data structures, etc., which perform particular tasks or implement data types. The camera controller 208, the environment identifier 210, the IoT camera mode creator 212, the image manager 214, the selection engine 216, and the device controller 218 may also be implemented as, signal processor(s), state machine(s), logic circuitries, and/or any other device or component that manipulate signals based on operational instructions. Further, the camera controller 208, the environment identifier 210, the IoT camera mode creator 212, the image manager 214, the selection engine 216, and the device controller 218 can be implemented in hardware, instructions executed by a processing unit, or by a combination thereof. The processing unit can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions.

According to an embodiment of the disclosure, the system 200 may be configured to create IoT camera modes using the user device in the IoT environment comprising the IoT devices. In said embodiment, the camera controller 208 may be configured to capture an image using the camera 206 of the user device based on a user input. Subsequent to the capturing of the image, the environment identifier 210 may be configured to determine a location associated with the captured image.

In an example for determining the location associated with the captured image, the environment identifier 210 may analyze the device states and the device feeds. For instance, a feed from a camera or a vision sensor installed in the IoT environment may be used. Furthermore, operation states of the IoT devices may be analyzed for ascertaining the location. For instance, the user may be constantly interacting with an IoT device, say, a television. Accordingly, the location of the user device may be ascertained. Furthermore, in other examples, indoor localization or positioning system with wireless fidelity (Wi-Fi) positioning system (WPS) calibration may be used for determining the location of the user device.

Furthermore, the environment identifier 210 may be configured to determine an operation setting of each of a set of devices from the plurality of devices of the IoT environment. Herein, the set of devices are the devices that are associated with the location of the captured image. In other words, the set of devices include the devices that are present at or in the vicinity of the location at which the image is captured. In an example, the environment identifier 210 may analyze the captured image to ascertain the devices present at the location. For identifying the devices that are not there in the captured image, the environment identifier 210 may query a database comprising IoT device data. The IoT device data includes data corresponding to the deployment of the IoT devices within the IoT environment. In an example, the IoT device data may be stored in the central storage 220. Accordingly, the environment identifier 210 may query the central storage 220 using the location to identify the devices that are associated with the location.

Once the set of devices are identified, the environment identifier 210 then determines an operation setting of each of the set of devices. To this end, the environment identifier 210 may query the gateway 106 and may learn about the operation settings of each of the set of devices. In an example, the operation settings may also include a current operation state of the devices as well. In an example, the operation settings associated with the set of devices may be referred to as operation data and may be stored in the central storage 220.

Subsequently, based on the location and the operation data, the IoT camera mode creator 212 may be configured to create an IoT camera mode. Also, the IoT camera mode creator 212 stores IoT metadata in a mapped relationship with the created IoT camera mode. The IoT metadata includes the determined location and the operation data. Furthermore, the IoT camera mode creator 212 further is to store the IoT camera mode and the IoT metadata in the central storage 220, in an example. The central storage 220 is accessible using the user device and other user devices present in the IoT environment. Thus, the created IoT camera mode may be used subsequently for recreating past ambience in real-time and capturing images therein.

In a further example, the image manager 214 may be configured to store the captured image as well in the central storage 220. As mentioned above, the central storage 220 is accessible using the user device and other user devices present in the IoT environment. Accordingly, in an example embodiment, during capturing of subsequent images, a user may be presented with pre-stored images associated with the determined location for recreating past ambiences. The user may accordingly select an image, and the past ambience would then be recreated for capturing the image.

In a further example, along with the location, a context associated with the captured image may also be determined. For identifying the context associated with the captured image, the environment identifier 210 may implement any of the standard image processing techniques that implement AI and/or machine learning and/or neural networks for determining contexts based on multimedia. In an example, the environment identifier 210 may determine the context. The context may be stored in the IoT metadata. Thus, the IoT metadata may include the determined location, the operation data of the set of devices present at the location, and the context, in an example.

As may be understood from above description, as and when the users registered with the IoT environment capture images, the central storage 220 gets populated with images and IoT metadata, and IoT camera modes. Said pre-stored images or IoT camera modes may be used at a future time instance by a user to recreate a past ambience and thereafter capture images in the recreated past ambience. In an example, as per the setting of the user device, the user may be provided with IoT camera modes for recreating past ambience for capturing images. In another example, as per the setting of the user device, the user may be provided with pre-stored images for recreating past ambience for capturing images. In an example, the setting of the user device may be selected by the user.

In an example embodiment, a user may seek to capture an image using the user device 104. In said example embodiment, the environment identifier 210 may be configured to determine a location within the environment 100, based on a camera preview frame recorded by the camera 206 of the user device 104. The determination of the location may be done in a similar manner as explained above.

In an example embodiment where the user device setting is to provide IoT camera modes to the user, the selection engine 216 may be configured to provide one or more candidate IoT camera modes for selection to the user based on the determined location. Herein, as explained earlier, each of the one or more candidate IoT camera modes corresponds to a past ambience relative to operation of a set of IoT devices associated with the determined location. In an example, for providing the candidate IoT camera modes, the selection engine 216 may be configured to access the central storage 220 comprising the plurality of IoT camera modes. As explained above, each of the plurality of IoT camera modes has IoT metadata associated therewith and the IoT metadata comprises a location, operation data. After accessing the central storage 220, the selection engine 216 may identify the one or more IoT camera modes from the plurality of IoT camera modes based on the determined location. For instance, the selection engine 216 may query the IoT metadata stored in the central storage 220 using the determined location. Accordingly, as a result of the query, the selection engine 216 may learn about the one or more IoT camera modes having a location similar to the determined location. Said one or more IoT camera modes are then selected and the selection engine 216 may display the one or more IoT camera modes on a display of the user device 104 for user selection.

Post providing of the IoT camera modes for selection to the user, the selection engine 216 may be configured to receive a selection of a candidate IoT camera mode from the one or more candidate IoT camera modes based on a user input. In an example, at first, the selection engine 216 may receive a trial selection of a candidate IoT camera mode from the one or more candidate IoT camera modes. In response to the trial selection of the candidate IoT camera mode, the device controller 218 may be configured to control an operation of each of the set of IoT devices based on the operation data included in the IoT metadata associated with the candidate IoT camera mode for re-creating the corresponding past ambience. Herein, the operation setting of the devices may be learnt from the IoT metadata and accordingly, the set of IoT devices may be operated based on the stored operation settings to recreate the past ambience. As the past ambience is recreated, the camera controller 208 may be configured to update the camera preview frame based on the recreated past ambience. Based on the camera preview frame now, the user may make the selection of the candidate IoT camera mode. As may be understood, the user may perform trial selection for more than one candidate IoT camera mode.

Once the candidate IoT camera mode is selected, the device controller 218 may recreate the past ambience. Thereafter, the camera controller 208 may be configured to capture the image in the re-created past ambience using the camera 206 of the user device 104 based on a user input.

In another example embodiment where the user device setting is to provide pre-stored images to the user, once the location is determined, the selection engine 216 may be configured to provide one or more pre-stored images for selection to the user based on the location. Herein, the one or more pre-stored images are provided to the user for selection in a manner similar to the providing of the one or more IoT camera modes. That is, the selection engine 216 may be configured to query the central storage 220 based on the determined location and then using the IoT metadata associated with the pre-stored images, determine the one or more pre-stored images.

Continuing further, in an example, the selection engine 216 may subsequently receive a user input for selection of a pre-stored image from the one or more pre-stored images. In the embodiment, unlike the above embodiment, the operation of each of the set of IoT devices is not controlled during the trial selection of the pre-stored images. Herein, in response to the trial selection of a pre-stored image, the camera controller 208 may be configured to update the camera preview frame based on the trial-selected pre-stored image for re-creating the corresponding past ambience in the camera preview frame itself. To that end, the camera controller 208 may be configured to apply a plurality of visual effects on the camera preview frame based on the IoT metadata associated with the trial-selected pre-stored image. For instance, based on the operation data, the operation settings of the IoT devices may be learnt. As an example, in a room, it may be learnt that light A, B, were on, whereas, light C was off. Accordingly, the camera controller 208 may apply the visual effects onto the preview frame. Furthermore, image characteristics of the selected pre-stored image may also be used, in an example, for applying the visual effects.

Once the user makes a selection of the pre-stored image, the device controller 218 may recreate the past ambience associated with the pre-stored image. Accordingly, the device controller 218 may control an operation of each of the set of IoT devices based on the IoT metadata associated with the selected pre-stored image, for re-creating the past ambience in real-time. Once the past ambience is recreated, the camera controller 208 may be configured to capture the image in the re-created past ambience using the camera 206 of the user device based on further a user input.

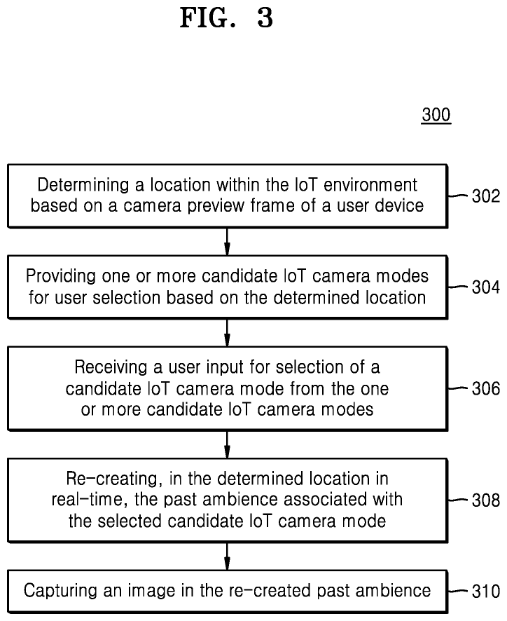

FIG. 3 illustrates a method 300 of capturing images using a user device in an IoT environment comprising IoT devices, according to an embodiment of the disclosure.

Referring to FIG. 3, the method 300 may be implemented in the system 200 using components thereof, as described above. In an embodiment, the method 300 may be executed by the processor 202, and/or one or more units coupled thereto, as described above. Further, for the sake of brevity, details of the disclosure that are explained in detail in the description of FIGS. 1 and 2 are not explained in detail in the description of FIG. 3.

At operation 302, a location within an IoT environment is determined based on a camera preview frame of a user device. In an example, the location may be determined based on indoor positioning systems or localizations systems, and machine learning, AI, neural network based techniques as mentioned above. Furthermore, besides the location, a context may also be determined based on the camera preview frame. In an example, the environment identifier 210 may determine the location within the environment based on the camera preview frame captured by camera 206 of the user device 104. The environment identifier 210 may also determine the context based on the camera preview frame. The determination of the context, in an example, may be done by implementing one or more of image processing techniques, artificial intelligence techniques, machine learning techniques, deep learning techniques, and the like.

At operation 304, one or more candidate IoT camera modes are provided for user selection based on the location. In an example, IoT metadata corresponding to a plurality of IoT camera modes that is stored in a central storage may be accessed and queried using the location to select the one or more candidate IoT camera modes. Accordingly, the one or more candidate IoT camera modes may be identified. Said candidate IoT camera modes have a location similar to the determined location. In an example, the selection engine 216 may provide the candidate IoT camera modes to the user through a display of the user device for user selection.

At operation 306, a user input is received for selection of a candidate IoT camera mode from the one or more candidate IoT camera modes. In an example, the step of selection involves receiving trial selection of a candidate IoT camera mode. Accordingly, operation of a set of IoT devices corresponding to the trial selected candidate IoT camera mode may be controlled based on IoT metadata associated therewith, for recreating a past ambience in real time. The past ambience is relative to the operation of the IoT devices in the past. Once the past ambience is created, the user may either select the candidate IoT camera mode or may make a trial selection of another candidate IoT camera mode as desired. Thus, the selection of the candidate IoT camera mode is made in said manner. In an example, the selection engine 216 may receive the selection of the candidate IoT camera mode.

At operation 308, the past ambience associated with the selected candidate IoT camera mode is re-created in the determined location in real time. To that end, an operation of each of the set of IoT devices may be controlled based on the IoT metadata associated with the selected IoT camera mode for re-creating the past ambience. In an example, the device controller 218 may re-create the past ambience associated with the selected candidate IoT camera mode in the determined location in real-time.

At operation 310, an image may be captured in the re-created past ambience using the user device. In an example, the camera controller may capture the image using the camera 206 of the user device.

As mentioned above, the context associated with the camera preview frame may also be determined. In an example, the IoT metadata may further comprise context data associated with the plurality of IoT camera modes. Accordingly, the one or more IoT camera modes may further be provided based on the context. In that case, a context may be determined based on the camera preview frame, as explained above. Based thereon, the determined context may be used to identify the one or more IoT camera modes that have a similar context associated thereto.

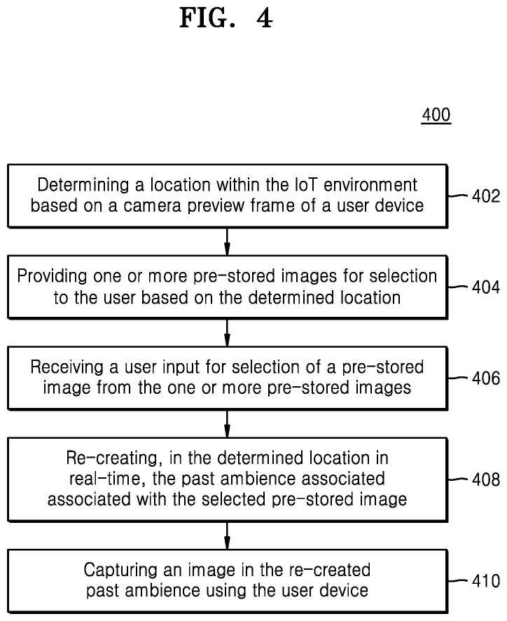

FIG. 4 illustrates a method 400 of capturing images using a user device in an IoT environment comprising IoT devices, according to an embodiment of the disclosure.

Referring to FIG. 4, the method 400 may be implemented in the system 200 using components thereof, as described above. In an embodiment, the method 400 may be executed by the processor 202, and/or one or more units coupled thereto, as described above. Further, for the sake of brevity, details of the disclosure that are explained in detail in the description of FIGS. 1 and 2 are not explained in detail in the description of FIG. 4.

At operation 402, a location within an IoT environment is determined based on a camera preview frame of a user device. In an example, the location may be determined based on indoor positioning systems or localizations systems, and machine learning, AI, neural network based techniques as mentioned above. Furthermore, besides the location, a context may also be determined based on the camera preview frame. In an example, the environment identifier 210 may determine the location within the environment based on the camera preview frame captured by camera 206 of the user device 104. The environment identifier 210 may also determine the context based on the camera preview frame. The determination of the context, in an example, may be done by implementing one or more of image processing techniques, artificial intelligence techniques, machine learning techniques, deep learning techniques, and the like.

At operation 404, one or more pre-stored images are provided for user selection based on the location. In an example, IoT metadata corresponding to a plurality of pre-stored images that is stored in a central storage may be accessed and queried using the location to select the one or more pre-stored images. Accordingly, the one or more pre-stored images may be identified. Said pre-stored images have a location similar to the determined location. In an example, the selection engine 216 may provide the pre-stored images to the user through a display of the user device for user selection.

At operation 406, a user input is received for selection of a pre-stored image from the one or more pre-stored images. In an example, the step of selection involves receiving trial selection of a pre-stored image. Based on the IoT metadata and/or image characteristics of the selected pre-stored image, the camera preview frame may be updated for recreating the past ambience in the camera preview frame. The past ambience is relative to the operation of the IoT devices in the past. Based on the camera preview frame, in an example, the user may either choose to select the pre-stored image or may make a trial selection of another pre-stored image. Thus, the selection of the pre-stored image is made in said manner. In an example, the selection engine 216 may receive the selection of the pre-stored image.

At operation 408, the past ambience associated with the selected pre-stored image is recreated. To that end, an operation of each of the set of IoT devices is controlled based on the IoT metadata associated with the selected pre-stored image for re-creating a past ambience in real-time. In an example, the device controller 218 may re-create the past ambience associated with the selected pre-stored image in the determined location in real-time.

At operation 410, an image may be captured in the re-created past ambience using the user device. In an example, the camera controller may capture the image using the camera 206 of the user device.

As mentioned above, the context associated with the camera preview frame may also be determined. In an example, the IoT metadata may further comprises context data associated with the plurality of pre-stored images. Accordingly, one or more pre-stored images may further be provided based on the context. In said case, a context may be determined based on the camera preview frame, as explained above. Based thereon, the determined context may be used to identify the one or more pre-stored images that have a similar context associated thereto.

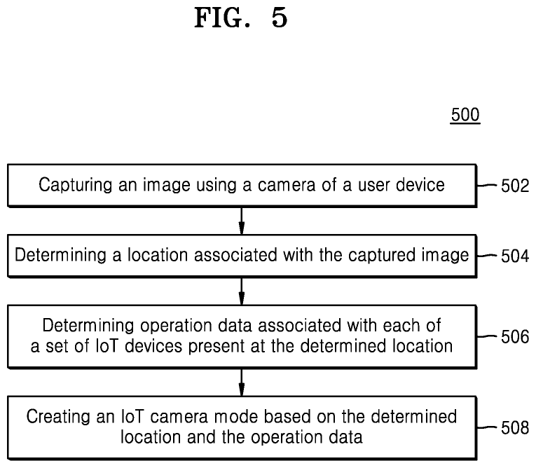

FIG. 5 illustrates a method 500 of creating IoT camera modes using a user device in an IoT environment comprising IoT devices, according to an embodiment of the disclosure.

Referring to FIG. 5, the method 500 may be implemented in the system 200 using components thereof, as described above. In an embodiment, the method 500 may be executed by the processor 202, and/or one or more units coupled thereto, as described above. Further, for the sake of brevity, details of the disclosure that are explained in detail in the description of FIGS. 1 and 2 are not explained in detail in the description of FIG. 5.

At operation 502, an image is captured using a camera of a user device. At operation 504, the method comprises identifying a location associated with the captured image. At operation 506, the method comprises determining operation data associated with each of a set of devices present at the determined location. The operation data may include an operation setting of each of the set of devices. Herein, in an example, the set of devices may include devices that have been identified from the captured image. In another example, the other devices that are present in the vicinity may be identified based on IoT device data. The IoT device data comprises information about deployment of IoT devices in the IoT environment. Accordingly, a location of the user device may be learnt and IoT devices in the vicinity thereof may be identified.

At operation 508, an IoT camera mode is created based on the location and the operation data. Furthermore, the created IoT camera mode is stored in a central storage, in an example. The central storage is accessible by said user device and other user devices present within the IoT environment. Furthermore, in said method, the captured image and IoT metadata associated therewith may also be stored in the central storage. The IoT metadata comprises the location and the operation data. Furthermore, a context associated with the captured image may also be determined and stored in the IoT metadata. The context may further be used in some examples for selecting IoT camera modes when the user is intending to capture images using the user device.

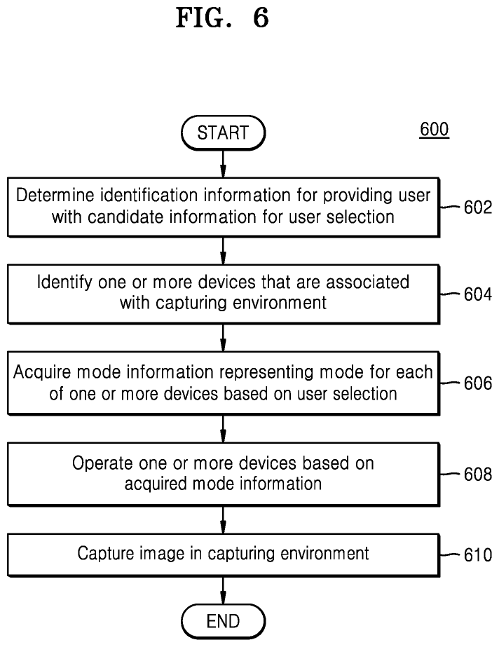

FIG. 6 illustrates a flow chart of an operating method 600 of an electronic device according to an embodiment of the disclosure.

Referring to FIG. 6, in operation 602, the electronic device may determine identification information providing a user with candidate information for a user selection. For example, the identification information may comprise: location information representing a location associated with the electronic device; and context information representing a content associated with the capturing environment.

In operation 604, the electronic device may identify one or more devices that are associated with the capturing environment. For example, the one or more devices may comprise a light.

In operation 606, the electronic device may acquire mode information representing a mode for each of the one or more devices based on the user selection. According to an embodiment of the disclosure, the candidate information comprises candidate mode information may include one or more candidate modes for each of the one or more devices. The electronic device may obtain the candidate mode information including the one or more candidate modes for each of the one or more devices based on the determined identification information. The electronic device may acquire the mode information based on a reference mode selected by the user among the one or more candidate modes. Selectively, the candidate mode information is stored in a memory. The candidate mode information stored in the memory is updated based on the captured image, the identification information and the acquired mode information. The electronic device may provide the candidate mode information to the user through a display and receive information associated with the reference mode selected by the user.

According to another embodiment of the disclosure, the candidate information may comprise one or more candidate reference images. The electronic device may obtain the one or more candidate reference images based on the determined identification information. The electronic device may acquire a reference image selected by a user among the one or more candidate reference images and identify the mode for each of the one or more devices based on the acquired reference image. For example, data associated with the one or more candidate reference images is stored in a memory. The data associated with the one or more candidate reference images stored in the memory is updated based on the captured image, the identification information and the acquired reference image. The electronic device may display the one or more candidate reference images for the user selection and receive information associated with the reference image selected by the user.

In operation 608, the electronic device may operate the one or more devices based on the acquired mode information. For example, the electronic device may change a brightness of the light based on the mode information.

In operation 610, the electronic device may capture an image in the capturing environment.

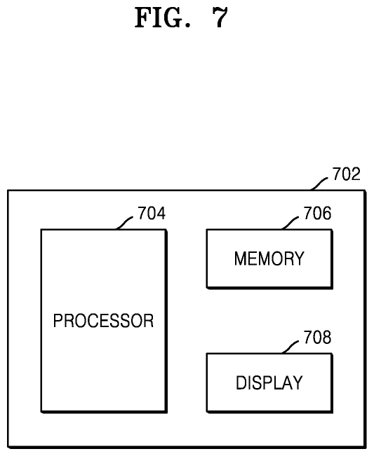

FIG. 7 illustrates a block diagram of an electronic device 702 in accordance with an embodiment of the disclosure.

Referring to FIG. 7, the electronic device 702 may comprise a processor 704, a memory 706 and a display 708.

The processor 704 may determine identification information for providing a user with candidate information for a user selection and identify one or more devices that are associated with the capturing environment. For example, the identification information may comprise location information representing a location associated with the electronic device and context information representing a content associated with the capturing environment.

The processor 704 may acquire mode information representing a mode for each of the one or more devices based on the user selection. For example, the candidate information may comprise candidate mode information including one or more candidate modes for each of the one or more devices. The processor 704 may obtain the candidate mode information including the one or more candidate modes for each of the one or more devices based on the determined identification information. The processor 704 may acquire the mode information based on a reference mode selected by the user among the plurality of candidate modes.

For example, the candidate information may comprise one or more candidate reference images. The processor 704 may obtain the one or more candidate reference images based on the determined identification information. The processor 704 may acquire a reference image selected by a user among the one or more candidate reference images and identify the mode for each of the one or more devices based on the acquired reference image.

The processor 704 may operate the one or more devices based on the acquired mode information. For example, the one or more devices may comprise a light, and the processor 704 may change a brightness of the light based on the mode information.

The processor 704 may capture an image in the capturing environment.

The memory 706 may store the candidate mode information and data associated with the one or more candidate reference images are stored in the memory. The candidate mode information is updated based on the captured image, the identification information and the acquired mode information. The data associated with the one or more candidate reference images is updated based on the captured image, the identification information and the acquired reference image.

The display 708 may provide the candidate mode information to the user and provide the one or more candidate reference images for the user selection.

In an embodiment, a method of capturing an image using a user device in an IoT environment comprising a plurality of IoT devices is disclosed. The method comprises determining a location within the IoT environment based on a camera preview frame of a user device. The method further comprises providing one or more candidate IoT camera modes for user selection based on the determined location, where each of the one or more candidate IoT camera modes corresponds to a past ambience relative to operation of a set of IoT devices associated with the determined location. The method further comprises receiving a user input for selection of a candidate IoT camera mode from the one or more candidate IoT camera modes. Further, the method comprises recreating, in the determined location in real-time, the past ambience associated with the selected candidate IoT camera mode. Further, the method comprises capturing an image in the re-created past ambience using the user device.

In an embodiment, the step of re-creating further comprises controlling an operation of each IoT device of the set of IoT devices based on IoT metadata associated with the selected IoT camera mode, wherein the IoT metadata comprises past operation data associated with the plurality of IoT devices.

In an embodiment, the method further comprises identifying the set of IoT devices from the plurality of IoT devices, based on at least one of: the camera preview frame; and the determined location and IoT device data comprising information about deployment locations of the plurality of IoT devices.

In an embodiment, the method further comprises receiving a trial selection of a candidate IoT camera mode from the one or more candidate IoT camera modes; re-creating past ambience corresponding based on IoT metadata associated with the trial-selected candidate IoT camera mode, wherein the IoT metadata comprises past operation data associated with the plurality of IoT devices; and updating the camera preview frame based on the re-created past ambience.

In an embodiment, the providing of the one or more IoT camera modes for user selection comprises: accessing a central storage comprising a plurality of IoT camera modes, wherein each of the plurality of IoT camera modes has IoT metadata associated therewith, wherein the IoT metadata comprises location data associated with each of the plurality of IoT devices; identifying the one or more IoT camera modes from the plurality of IoT camera modes based on the determined location and the IoT metadata associated with the plurality of IoT camera modes; and displaying the one or more IoT camera modes on a display of a user device for user selection.

In an embodiment, the IoT metadata further comprises context data associated with the plurality of IoT camera modes. The providing of the one or more IoT camera modes further comprises: determining a context based on the camera preview frame; and identifying the one or more IoT camera modes further based on determined context and the context data.

In an embodiment, a system for implementing the aforementioned method is also disclosed. The system may be implemented in a user device, such as, for example, a smartphone, a laptop, a tablet, and the like. Without limitation, the system may be implemented in a distributed manner as well involving one or more of other devices, such as a gateway, a cloud server, a cloud storage, and the like.

In an embodiment, a method of capturing an image using a user device in an Internet of Things (IoT) environment comprising a plurality of IoT devices is disclosed. The method comprises determining a location within the IoT environment based on a camera preview frame of a user device. The method further comprises providing one or more pre-stored images for selection to the user based on the determined location, where each of the one or more pre-stored images corresponds to a past ambience relative to operation of a set of IoT devices associated with the determined location. The method further comprises receiving a user input for selection of a pre-stored image from the one or more pre-stored images. The method further comprises re-creating, in the determined location in real-time, the past ambience associated with the selected pre-stored image. The method further comprises capturing an image in the re-created past ambience using the user device.

In an embodiment, the step of re-creating further comprises controlling an operation of each IoT device of the set of IoT devices based on IoT metadata associated with the selected pre-stored image, wherein the IoT metadata comprises past operation data associated with the plurality of IoT devices.

In an embodiment, the method further comprises identifying the set of IoT devices from the plurality of IoT devices, based on at least one of: the camera preview frame; and the determined location and IoT device data comprising information about deployment locations of the plurality of IoT devices.

In an embodiment, the method further comprises: receiving a trial selection of a pre-stored image from the one or more pre-stored images; and updating the camera preview frame based on the trial-selected pre-stored image for re-creating the corresponding past ambience in the camera preview frame.

In an embodiment, the updating of the camera preview frame comprises applying a plurality of visual effects on the camera preview frame based on IoT metadata associated with the trial-selected pre-stored image, wherein the IoT metadata comprises past operation data associated with the plurality of IoT devices.

In an embodiment, the providing of the one or more pre-stored images for selection to the user comprises: accessing a central storage comprising a plurality of pre-stored images, wherein each of the plurality of pre-stored images has IoT metadata associated therewith, wherein the IoT metadata comprises location data associated with each of the plurality of IoT devices; identifying the one or more pre-stored images from the plurality of pre-stored images based on the determined location and the IoT metadata associated with the plurality of pre-stored images; and displaying the one or more pre-stored images on a display of a user device for user location.

In an embodiment, the IoT metadata further comprises context data associated with the plurality of pre-stored images, and wherein the providing of the one or more pre-stored images further comprises: determining a context based on the camera preview frame; and identifying the one or more pre-stored images further based on the context data.

In an embodiment, a system for implementing the aforementioned method is also disclosed. The system may be implemented in a user device, such as, for example, a smartphone, a laptop, a tablet, and the like. Without limitation, the system may be implemented in a distributed manner as well involving one or more of other devices, such as a gateway, a cloud server, a cloud storage, and the like.

In yet another embodiment, a method of creating an IoT camera mode using a user device in an Internet of Things (IoT) environment comprising a plurality of IoT devices is disclosed. The method comprises capturing an image using a camera of the user device. The method further comprises determining a location associated with the captured image. The method further comprises determining operation data associated with each of a set of IoT devices present at the determined location. The method further comprises creating an IoT camera mode based on the determined location and the operation data.

In an embodiment, the method further comprises: storing the IoT camera mode in a central storage accessible using the user device and other user devices present in the IoT environment; and storing IoT metadata associated with the IoT camera mode in the central storage, wherein the IoT metadata comprises the operation data and the determined location.

In an embodiment, the method further comprises: determining a context associated with the captured image; and storing the context as context data in the IoT metadata.

In an embodiment, a system for implementing the aforementioned method is also disclosed. The system may be implemented in a user device, such as, for example, a smartphone, a laptop, a tablet, and the like. Without limitation, the system may be implemented in a distributed manner as well involving one or more of other devices, such as a gateway, a cloud server, a cloud storage, and the like.

According to an embodiment of the disclosure, a system for capturing an image using a user device in an Internet of Things (IoT) environment comprising a plurality of IoT devices is provided. The system comprises: an environment identifier configured to determine a location within the IoT environment based on a camera preview frame of the user device; a selection engine configured to: provide one or more candidate IoT camera modes for user selection based on the determined location, wherein each of the one or more candidate IoT camera modes corresponds to a past ambience relative to operation of a set of IoT devices associated with the determined location; and receive a user input for selection of a candidate IoT camera mode from the one or more candidate IoT camera modes; a device controller configured to recreate, in the determined location in real-time, the past ambience associated with the selected candidate IoT camera mode; and a camera controller configured to capture an image in the re-created past ambience using a camera of the user device.

In an embodiment, the device controller further is to control an operation of each IoT device of the set of IoT devices based on IoT metadata associated with the selected IoT camera mode, wherein the IoT metadata comprises past operation data associated with the plurality of IoT devices.

In an embodiment, the selection engine further is to identify the set of IoT devices from the plurality of IoT devices, based on at least one of: the camera preview frame; and the determined location and IoT device data comprising information about deployment locations of the plurality of IoT devices.

In an embodiment, the selection engine further is to receive a trial selection of a candidate IoT camera mode from the one or more candidate IoT camera modes; the device controller further is to re-create past ambience corresponding based on IoT metadata associated with the trial-selected candidate IoT camera mode, wherein the IoT metadata comprises past operation data associated with the plurality of IoT devices; and the camera controller further is to update the camera preview frame based on the re-created past ambience.

In an embodiment, the selection engine further is to: access a central storage comprising a plurality of IoT camera modes, wherein each of the plurality of IoT camera modes has IoT metadata associated therewith, wherein the IoT metadata comprises location data associated with each of the plurality of IoT devices; identify the one or more IoT camera modes from the plurality of IoT camera modes based on the determined location and the IoT metadata associated with the plurality of IoT camera modes; and display the one or more IoT camera modes on a display of the user device for user selection.

In an embodiment, the IoT metadata further comprises context data associated with the plurality of IoT camera modes, and wherein: the environment identifier is further configured to determine a context based on the camera preview frame; and the selection engine is further configured to identify the one or more IoT camera modes further based on determined context and the context data.

According to an embodiment of the disclosure, a system for creating an IoT camera mode using a user device in an Internet of Things (IoT) environment comprising a plurality of IoT devices, the system comprising: a camera controller configured to capture an image using a camera of the user device; an environment identifier configured to; determining a location where the image is captured and a context associated with the captured image; and determine operation data associated with each of a set of IoT devices present at the determined location; and an IoT camera mode creator configured to create an IoT camera mode based on the determined location and the operation data.

In an embodiment, the device controller further is to control an operation of each IoT device of the set of IoT devices based on IoT metadata associated with the selected pre-stored image, wherein the IoT metadata comprises past operation data associated with the plurality of IoT devices.

In an embodiment, the selection engine further is to identify the set of IoT devices from the plurality of IoT devices, based on at least one of: the camera preview frame; and the determined location and IoT device data comprising information about deployment locations of the plurality of IoT devices.

In an embodiment, the selection engine further is to receive a trial selection of a pre-stored image from the one or more pre-stored images; and the camera controller further is to update the camera preview frame based on the trial-selected pre-stored image for re-creating the corresponding past ambience in the camera preview frame.

In an embodiment, the camera controller further is to apply a plurality of visual effects on the camera preview frame based on IoT metadata associated with the trial-selected pre-stored image, wherein the IoT metadata comprises past operation data associated with the plurality of IoT devices.

In an embodiment, the selection engine further is to: access a central storage comprising a plurality of pre-stored images, wherein each of the plurality of pre-stored images has IoT metadata associated therewith, wherein the IoT metadata comprises location data associated with each of the plurality of IoT devices; identify the one or more pre-stored images from the plurality of pre-stored images based on the determined location and the IoT metadata associated with the plurality of pre-stored images; and display the one or more pre-stored images on a display of the user device for user selection.

In an embodiment, the IoT metadata further comprises context data associated with the plurality of IoT camera modes, and wherein: the environment identifier is further configured to determine a context based on the camera preview frame; and the selection engine is further configured to identify the one or more pre-stored images further based on determined context and the context data.

According to an embodiment of the disclosure, a system for creating an IoT camera mode using a user device in an Internet of Things (IoT) environment comprising a plurality of IoT devices is provided. The system comprises: a camera controller configured to capture an image using a camera of the user device; an environment identifier configured to: determining a location where the image is captured and a context associated with the captured image; and determine operation data associated with each of a set of IoT devices present at the determined location; and an IoT camera mode creator configured to create an IoT camera mode based on the determined location and the operation data.

In an embodiment, the IoT camera mode creator further is to: store the IoT camera mode in a central storage accessible using the user device and other user devices present in the IoT environment; and store IoT metadata associated with the IoT camera mode in the central storage, wherein the IoT metadata comprises the operation data and the determined location.

In an embodiment, the environment identifier further is to: determine a context associated with the captured image; and store the context as context data in the IoT metadata.

According to an embodiment of the disclosure, a method performed by an electronic device in a capturing environment is disclosed. The method may comprise: determining identification information for providing a user with candidate information for a user selection; identifying one or more devices that are associated with the capturing environment; acquiring mode information representing a mode for each of the one or more devices based on the user selection; operating the one or more devices based on the acquired mode information; and capturing an image in the capturing environment.

In an embodiment, the identification information may comprise: location information representing a location associated with the electronic device; and context information representing a content associated with the capturing environment.

In an embodiment, the candidate information comprises candidate mode information including one or more candidate modes for each of the one or more devices, and the acquiring of the mode information comprises: based on the determined identification information, obtaining the candidate mode information including the one or more candidate modes for each of the one or more devices; and acquiring the mode information based on a reference mode selected by the user among the one or more candidate modes.

In an embodiment, the candidate mode information is stored in a memory, wherein the one or more devices comprise a light, and wherein the operating of the one or more devices comprises: changing a brightness of the light based on the mode information.

In an embodiment, the method may further comprise: updating the candidate mode information stored in the memory based on the captured image, the identification information and the acquired mode information.

In an embodiment, the acquiring of the mode information may further comprise: providing the candidate mode information to the user through a display; and receiving information associated with the reference mode selected by the user.

In an embodiment, the candidate information comprises one or more candidate reference images, and the acquiring of the mode information may comprise: based on the determined identification information, obtaining one or more candidate reference images; acquiring a reference image selected by a user among the one or more candidate reference images; and identifying the mode for each of the one or more devices based on the acquired reference image.

In an embodiment, data associated with the one or more candidate reference images is stored in a memory.

In an embodiment, the method may further comprise: updating the data associated with the one or more candidate reference images stored in the memory based on the captured image, the identification information and the acquired reference image.

In an embodiment, the acquiring of the mode information may further comprise: displaying the one or more candidate reference images for a user selection; and receiving information associated with the reference image selected by the user.

According to an embodiment of the disclosure, an electronic device in a capturing environment is disclosed. The electronic device may comprise: a display, a memory; and at least one processor configured to: determine identification information for providing a user with candidate information for a user selection; identifying one or more devices that are associated with the capturing environment; acquire mode information representing a mode for each of the one or more devices based on the user selection; operate the one or more devices based on the acquired mode information; and capture an image in the capturing environment.

In an embodiment, the identification information comprises: location information representing a location associated with the electronic device; and context information representing a content associated with the capturing environment.

In an embodiment, the candidate information comprises candidate mode information including one or more candidate modes for each of the one or more devices, and the at least one processor is further configured to: based on the determined identification information, obtain the candidate mode information including the one or more candidate modes for each of the one or more devices; and acquire the mode information based on a reference mode selected by the user among the one or more candidate modes.

In an embodiment, the candidate mode information is stored in the memory.

In an embodiment, the at least one processor is further configured to: update the candidate mode information stored in the memory based on the captured image, the identification information and the acquired mode information.

In an embodiment, the at least one processor is further configured to: provide the candidate mode information to the user via the display; and receive information associated with the reference mode selected by the user.

In an embodiment, the candidate information comprises one or more candidate reference images, and the at least one processor is further configured to: based on the determined identification information, obtain one or more candidate reference images; acquire a reference image selected by a user among the one or more candidate reference images; and identify the mode for each of the one or more devices based on the acquired reference image.

In an embodiment, data associated with the one or more candidate reference images is stored in the memory.

In an embodiment, the at least one processor is further configured to: update the data associated with the one or more candidate reference images stored in the memory based on the captured image, the identification information and the acquired reference image.

In an embodiment, the at least one processor is further configured to: provide the one or more candidate reference images for a user selection via the display; and receive information associated with the reference image selected by the user.

Embodiments have been described with reference to flowchart illustrations and/or block diagrams of methods, apparatus (systems), and computer program products. In some cases, each block of such illustrations/diagrams, or combinations thereof, can be implemented by computer program instructions. The computer program instructions when provided to a processor produce a machine, such that the instructions, which executed via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium,” and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, read-only memory (ROM), flash memory, disk drive memory, a compact disc read-only memory (CD-ROM), and other permanent storage. It is useful, for example, for transporting information, such as data and computer instructions, between computer systems. Computer program instructions may be stored in a computer readable medium that can direct a computer, other programmable data processing apparatuses, or other devices to function in a particular manner, such that the instructions stored in the computer readable medium produce an article of manufacture including instructions which implement the function/act specified in the flowchart and/or block diagram block(s).

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium (e.g., a non-transitory computer readable storage medium). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++, or the like, and procedural programming languages of the related art, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some cases, aspects of one or more embodiments are described above with reference to flowchart illustrations and/or block diagrams of methods, apparatuses (systems), and computer program products. In some instances, it will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s).

The computer program instructions may also be loaded onto a computer, other programmable data processing apparatuses, or other devices to cause a series of operations to be performed on the computer, other programmable apparatuses, or other devices to produce a computer implemented process such that the instructions which execute on the computer or other programmable apparatuses provide processes for implementing the functions/acts specified in the flowchart and/or block diagram block(s).

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device in a capturing environment, the method comprising:
determining identification information for providing a user with candidate information for a user selection;
identifying one or more devices that are associated with the capturing environment;
acquiring mode information representing a mode for each of the one or more devices based on the user selection;
operating the one or more devices based on the acquired mode information; and
capturing an image in the capturing environment.

2. The method of claim 1, wherein the identification information comprises:
location information representing a location associated with the electronic device; and
context information representing a content associated with the capturing environment.

3. The method of claim 1,
wherein the candidate information comprises candidate mode information including one or more candidate modes for each of the one or more devices, and
wherein the acquiring of the mode information comprises:
based on the determined identification information, obtaining the candidate mode information, and
acquiring the mode information based on a reference mode selected by the user among the one or more candidate modes.

4. The method of claim 3,
wherein the candidate mode information is stored in a memory,
wherein the one or more devices comprise a light, and
wherein the operating of the one or more devices comprises:
changing a brightness of the light based on the mode information.

5. The method of claim 4, the method further comprising:
updating the candidate mode information stored in the memory based on the captured image, the identification information and the acquired mode information.

6. The method of claim 3, wherein the acquiring of the mode information further comprises:
providing the candidate mode information to the user through a display; and
receiving information associated with the reference mode selected by the user.

7. The method of claim 1,
wherein the candidate information comprises one or more candidate reference images, and
wherein the acquiring of the mode information comprises:
based on the determined identification information, obtaining the one or more candidate reference images,
acquiring a reference image selected by a user among the one or more candidate reference images, and
identifying the mode for each of the one or more devices based on the acquired reference image.

8. The method of claim 7, wherein data associated with the one or more candidate reference images is stored in a memory.

9. The method of claim 8, the method further comprising:
updating the data associated with the one or more candidate reference images stored in the memory based on the captured image, the identification information and the acquired reference image.

10. The method of claim 7, wherein the acquiring of the mode information further comprises:
displaying the one or more candidate reference images for the user selection, and
receiving information associated with the reference image selected by the user.

11. An electronic device in a capturing environment, the electronic device comprising:
a display;
a memory; and
at least one processor configured to:
determine identification information for providing a user with candidate information for a user selection,
identify one or more devices that are associated with the capturing environment,
acquire mode information representing a mode for each of the one or more devices based on the user selection,
operate the one or more devices based on the acquired mode information, and
capture an image in the capturing environment.

12. The electronic device of claim 11, wherein the identification information comprises:
location information representing a location associated with the electronic device; and
context information representing a content associated with the capturing environment.

13. The electronic device of claim 11,
wherein the candidate information comprises candidate mode information including one or more candidate modes for each of the one or more devices, and
wherein the at least one processor is further configured to:
based on the determined identification information, obtain the candidate mode information, and
acquire the mode information based on a reference mode selected by the user among the one or more candidate modes.

14. The electronic device of claim 13,
wherein the candidate mode information is stored in the memory,
wherein the one or more devices comprise a light, and
wherein the at least one processor is further configured to change a brightness of the light based on the mode information.

15. The electronic device of claim 14, wherein the at least one processor is further configured to:
update the candidate mode information stored in the memory based on the captured image, the identification information, and the acquired mode information.

16. The electronic device of claim 13, wherein the at least one processor is further configured to:
provide the candidate mode information to the user via the display; and
receive information associated with the reference mode selected by the user.

17. The electronic device of claim 11,
wherein the candidate information comprises one or more candidate reference images, and
wherein the at least one processor is further configured to:
based on the determined identification information, obtain the one or more candidate reference images,
acquire a reference image selected by a user among the one or more candidate reference images, and
identify the mode for each of the one or more devices based on the acquired reference image.

18. The electronic device of claim 17, wherein data associated with the one or more candidate reference images is stored in the memory.

19. The electronic device of claim 18, wherein the at least one processor is further configured to:
update the data associated with the one or more candidate reference images stored in the memory based on the captured image, the identification information and the acquired reference image.

20. The electronic device of claim 17, wherein the at least one processor is further configured to:
provide the one or more candidate reference images for the user selection via the display, and
receive information associated with the reference image selected by the user.
